(19) United States
(12) Patent Application Publication
(10) Pub. No.: US 2010/0138626 A1
(43) Pub. Date: Jun. 3, 2010

(54) Use of reservation concepts in managing maintenance actions in a storage control system

(76) Inventors: James A. Lynn, Rose Hill, KS (US); Keith Kauffman, Wichita, KS (US)

Correspondence Address: LSI Corporation c/o Suiter Swantz pc llo, 14301 FNB Parkway, Suite 220, Omaha, NE, 68154, US

(21) Appl. No.: 12/315,306

(22) Filed: Dec. 2, 2008

(51) Int. Cl. G06F 12/02

(52) U.S. Cl. 711/170; 711/E12.006

(57) ABSTRACT

A computationally implemented method, system, and product for managing maintenance activities in a storage control system are disclosed. A disk drive has a reservation status that is monitored. A reservation ID is assigned to a successful reservation request. The reservation ID of a drive request is compared to the reservation ID of a disk drive.

### TECHNICAL FIELD

The present disclosure generally relates to the field of digital storage devices, and more particularly to a system, method, and product for managing maintenance applications on disk drives.

### BACKGROUND

Storage control systems are used in conjunction with disk drives for the management and storage of data. In the present art a central processor requires a storage control system in order to access data from disk drives. A typical storage control system contains disk drives to store data and a control processor to manage the storage of the data. The control processor executes an application to control storage and retrieval of disk drive data, but also executes various maintenance applications to perform maintenance activities on the disk drives. The storage control system may set a flag when a maintenance application accesses the disk drive. The flag starts a time interval during which storage and retrieval of disk drive data are suspended.

### SUMMARY

A computationally implemented method includes, but is not limited to: monitoring a disk drive reservation status; assigning a reservation ID to a successful reservation request; and determining whether a reservation ID of a drive request matches a reservation ID of a disk drive.

A computationally implemented system includes, but is not limited to: at least one disk drive; and a storage control processor for executing a reservation management application, the reservation management application further including: a reservation module configured for monitoring which disk drives have a reservation, an assignment module configured for assigning a reservation ID to a successful reservation request, said successful reservation request is determined upon receiving a reservation request and determining there is no reservation on a disk drive, and a comparison module configured for determining whether a reservation ID of a drive request matches a reservation ID of a disk drive upon receiving said drive request and determining said disk drive has a reservation.

A computer program product includes but is not limited to: one or more instructions for monitoring a disk drive reservation status; one or more instructions for assigning a reservation ID to a successful reservation request, said successful reservation request determined upon receiving a reservation request and determining there is no reservation on a disk drive; and one or more instructions for determining whether a reservation ID of a drive request matches a reservation ID of a disk drive upon receiving said drive request and determining said disk drive has a reservation.

It is to be understood that both the foregoing general description and the following detailed description are exemplary and explanatory only and are not necessarily restrictive of the present disclosure. The accompanying drawings, which are incorporated in and constitute a part of the specification, illustrate subject matter of the disclosure. Together, the descriptions and the drawings serve to explain the principles of the disclosure.

### BRIEF DESCRIPTION OF THE DRAWINGS

The numerous advantages of the disclosure may be better understood by those skilled in the art by reference to the accompanying figures in which:

FIG. 1 is a block diagram illustrating a storage control system according to an embodiment of the disclosure;

FIG. 2 is a flow diagram illustrating a method for processing drive requests;

FIG. 3 is a flow diagram illustrating a method for processing reservation requests;

FIG. 4 is a flow diagram illustrating a method for processing a reservation timer expiration;

FIG. 5 is a flow diagram illustrating a method for processing reservation cancellation requests; and

FIG. 6 is a block diagram of the reservation management application illustrated in FIG. 2.

### DETAILED DESCRIPTION

Reference will now be made in detail to the subject matter disclosed, which is illustrated in the accompanying drawings.

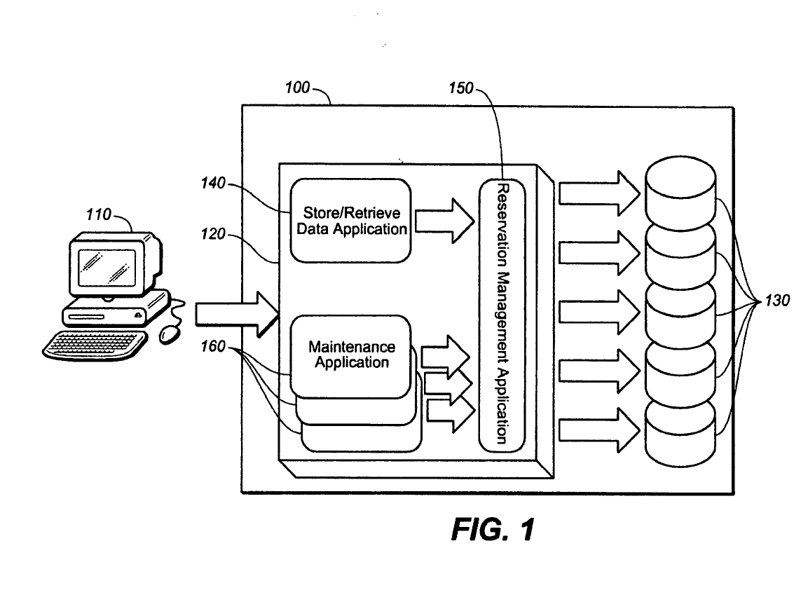

Describing now the invention with reference to FIG. 1, a block diagram illustrating a storage control system 100 according to an embodiment of the disclosure is shown. In an embodiment of the system 100, a central processor 110 may send a command to a storage control processor 120 to access at least one of the disk drives 130. The storage control processor 120 may execute a store/retrieve data application 140 capable of processing and sending a drive request. A drive request may be required to access at least one of the disk drives 130. The storage control processor 120 may execute at least one maintenance application 160 capable of performing at least one maintenance activity on at least one of the disk drives 130. A maintenance activity may include, but may not be limited to, downloading new firmware to at least one of the disk drives 130, determining if at least one of the disk drives 130 should be placed out of service, and running diagnostics on at least one of the disk drives 130. A maintenance application 160 may be configured to send a drive request.

As used herein, central processor 110 may be any computer which accesses at least one disk drive. As used herein, storage control processor 120 may be any processor which handles the details of storing data for a central processor 110. Examples of storage control processor 120 may include, but are not limited to, RAID storage processors which are in a separate physical enclosure from central processor 110 (e.g., so-called external RAID storage systems made by LSI and competitors), RAID storage processors which are contained on a printed-circuit board which is installed within the same physical enclosure as central processor 110 (e.g., so-called internal RAID storage processors made by LSI and competitors), and RAID storage processors which are implemented as part of the I/O driver within and executed by central processor 110 (e.g., so-called software RAID). Storage control processor 120 may not be limited to the implementation of RAID technology.

A reservation management application 150 may be configured to coordinate all drive requests. A reservation management application 150 may be configured to coordinate all maintenance activities. According to an embodiment of the present disclosure, a reservation management application 150 may be configured to require maintenance applications 160 to submit a reservation request to the reservation management application 150 in order to obtain disk drive access. The reservation management application 150 may be configured to require a store/retrieve data application 140 not to submit a reservation request to the reservation management application 150 in order to obtain disk drive access. According to an embodiment of the present disclosure, the reservation management application 150 may be configured to provide an interface between the store/retrieve data application 140 and the disk drives 130. The reservation management application 150 may also be configured to provide an interface between maintenance applications 160 and the disk drives 130.

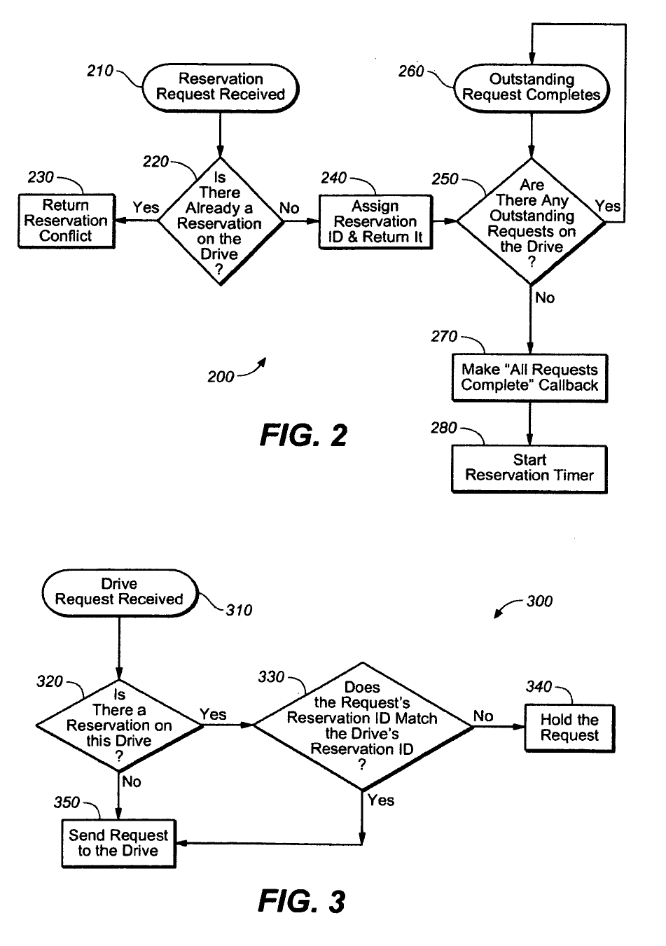

Referring to FIG. 2, a flow diagram illustrating a method 200 for processing reservation requests is shown. Step 210 depicts receiving a reservation request, the reservation request further identifying a disk drive. In an embodiment of the disclosure, the reservation request may further identify a timer duration. In another embodiment of the disclosure, only maintenance applications may be required to make reservation requests. Step 220 depicts confirming there is a reservation on the disk drive identified by the reservation request. Step 230 depicts returning a reservation conflict to the requesting application if a current reservation exists on the disk drive identified by the reservation request. Interference between two or more maintenance applications may be prevented or substantially reduced by permitting only one maintenance application to place a reservation on a disk drive. Step 240 depicts assigning a reservation ID to the disk drive identified by the reservation request and returning the reservation ID to the requesting application. Step 250 depicts confirming there are any outstanding drive requests on the disk drive identified by the reservation request. Maintenance application interference with a store/retrieve data application may be prevented or substantially reduced by confirming an outstanding drive request on the disk drive identified by the reservation request. Step 260 depicts receiving notification an outstanding drive request on the disk drive has completed. Step 270 depicts sending an “all requests complete” callback to the requesting application. More efficient scheduling of maintenance application drive requests may be increased by sending an “all requests complete” callback to the requesting maintenance application. Step 280 depicts starting a reservation timer. The reservation timer may identify a limit for the operation of a maintenance activity. In an embodiment of the disclosure, the duration of the reservation timer may be a fixed amount. In another embodiment of the disclosure, the duration of the reservation timer may be identified in the reservation request of the requesting maintenance application. In this embodiment of the disclosure, identifying the duration of the reservation timer in the reservation request may allow a variety of timing requirements for various maintenance activities. Identifying the duration of the reservation timer in the reservation request may allow for a maximum time duration for a maintenance activity if excessive errors are encountered during operation of the maintenance activity.

Referring to FIG. 3, a flow diagram illustrating a method 300 for processing drive requests is shown. Step 310 depicts receiving a drive request, the drive request further identifying a disk drive. A drive request may further identify a reservation ID. Step 320 depicts confirming a disk drive reservation on a disk drive identified by the drive request. Step 330 depicts comparing a reservation ID of a drive request to a disk drive ID. In an embodiment of the disclosure, a drive request made by a store/retrieve data application may not include a reservation ID. In another embodiment of the disclosure, a drive request made by a store/retrieve data application may include a well-known reservation ID which indicates the drive request is not associated with a reservation. Step 340 depicts queuing an unsuccessful drive request (e.g., a reservation ID of a drive request does not match a reservation ID of a disk drive). Interference between two or more applications may be prevented or substantially reduced by requiring a reservation ID of a drive request to match a reservation ID of a disk drive. Step 350 depicts sending a successful drive request to a disk drive (e.g., a reservation ID of a drive request matching a reservation ID of a disk drive identified by the drive request, or there is no current reservation on a disk drive identified by the drive request).

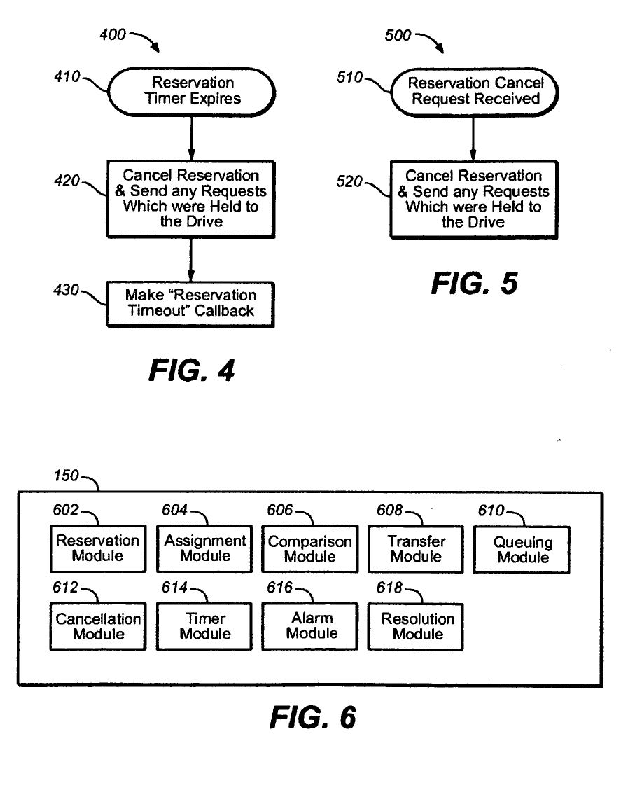

Referring to FIG. 4, a flow diagram illustrating a method 400 for processing a reservation timer expiration is shown. Step 410 depicts receiving notification a reservation timer has expired. Step 420 depicts canceling the reservation and sending all queued drive requests to the disk drive. Step 430 depicts sending a “reservation timeout” callback to the requesting application.

Referring to FIG. 5, a flow diagram illustrating a method 500 for processing reservation cancellation requests is shown. In step 510, a reservation cancel request is received. In step 520, the reservation on a disk drive is cancelled and all queued drive requests are sent to the disk drive. In this embodiment, a variety of timing requirements for a single maintenance application may be handled (e.g., a maintenance application may require more or less time to complete depending on the errors encountered). If a maintenance application finishes more quickly than anticipated, it may send a reservation cancellation request. The reservation management application may be configured to require a maintenance application to send a reservation cancellation request upon completion of the maintenance activity of the maintenance application. More efficient processing of drive access requests may be provided by requiring a maintenance application to send a reservation cancellation request upon completion of the maintenance activity of the maintenance application.

Referring to FIG. 6, a block diagram of the reservation management application 150 illustrated in FIG. 1 is shown. The reservation management application 150 may include a plurality of modules 602-618 for executing the reservation management application 150. A reservation module 602 may monitor a disk drive reservation status. An assignment module 604 may assign a reservation ID to a successful reservation request. A comparison module 606 may compare a reservation ID of a drive request and a reservation ID of a disk drive, and may also determine whether a reservation ID of a drive request matches a reservation ID of a disk drive. A transfer module 608 may determine and send a successful drive request (e.g., a reservation ID of a drive request matching a reservation ID of a disk drive) to a disk drive (e.g., the matching disk drive). A queuing module 610 may queue a drive request (e.g., if a drive request cannot be executed on a selected disk drive at a point in time). A cancellation module 612 may cancel a reservation and send all, substantially all, or at least a portion of queued drive requests to a disk drive. A timer module 614 may execute an “all requests complete” callback and start a reservation timer. An alarm module 616 may cancel a reservation, send all queued drive requests to a disk drive, and execute a “reservation timeout” callback. A resolution module 618 may return a reservation conflict to a maintenance application if a reservation request fails (e.g., a reservation already exists for a selected disk drive).

In the present disclosure, the methods disclosed may be implemented as sets of instructions, firmware and/or software readable by a device. Further, it is understood that the specific order or hierarchy of steps in the methods disclosed are examples of exemplary approaches. Based upon design preferences, it is understood that the specific order or hierarchy of steps in the method may be rearranged while remaining within the disclosed subject matter. The accompanying method claims present elements of the various steps in a sample order, and are not necessarily meant to be limited to the specific order or hierarchy presented.

It is believed that the present disclosure and many of its attendant advantages will be understood by the foregoing description, and it will be apparent that various changes may be made in the form, construction and arrangement of the components without departing from the disclosed subject matter or without sacrificing all of its material advantages. The form described is merely explanatory, and it is the intention of the following claims to encompass and include such changes.

What is claimed is:

1. A computationally implemented method comprising:
monitoring a disk drive reservation status;
assigning a reservation ID to a successful reservation request; and
determining whether a reservation ID of a drive request matches a reservation ID of a disk drive.

2. The computationally implemented method of claim 1, wherein said determining whether a reservation ID of a drive request matches a reservation ID of a disk drive includes:
determining whether a reservation ID of a drive request matches a reservation ID of a disk drive when said drive request is received and said disk drive has a reservation.

3. The computationally implemented method of claim 2, further including:
sending said drive request to said disk drive upon one of determining said disk drive does not have a reservation or determining said reservation ID of said drive request matches said reservation ID of said disk drive.

4. The computationally implemented method of claim 2, further including:
queuing said drive request upon determining said reservation ID of said drive request does not match said reservation ID of said disk drive.

5. The computationally implemented method of claim 4, further including:
canceling the reservation and sending all queued drive requests to said disk drive upon receiving a reservation cancel request.

6. The computationally implemented method of claim 4, further including:
determining whether said disk drive has an outstanding drive request upon one of said assigning a reservation ID to a successful reservation request or completion of an outstanding drive request on said disk drive.

7. The computationally implemented method of claim 6, further including:
sending an all requests complete callback upon determining said disk drive has no outstanding drive requests.

8. The computationally implemented method claim 6, further including:
starting a reservation timer upon determining said disk drive has no outstanding drive requests.

9. The computationally implemented method of claim 8, further including:
canceling the reservation and sending all queued drive requests to said disk drive upon expiration of said reservation timer.

10. The computationally implemented method of claim 8, further including:
sending a reservation timeout callback upon expiration of said reservation timer.

11. The computationally implemented method of claim 1, wherein said successful reservation request is determined upon receiving a reservation request and determining there is no reservation on a disk drive.

12. The computationally implemented method of claim 1, further including:
returning a reservation conflict upon receiving a reservation request and determining there is a reservation on a disk drive.

13. A storage control system comprising:
at least one disk drive; and
a storage control processor for executing a reservation management application, the reservation management application including:
a reservation module configured for monitoring which disk drives have a reservation,
an assignment module configured for assigning a reservation ID to a successful reservation request, said successful reservation request is determined upon receiving a reservation request and determining there is no reservation on a disk drive, and
a comparison module configured for determining whether a reservation ID of a drive request matches a reservation ID of a disk drive upon receiving said drive request and determining said disk drive has a reservation.

14. The storage control system of claim 13, wherein said reservation management application further includes:
a transfer module configured for sending said drive request to said disk drive upon one of determining said disk drive does not have a reservation or determining said reservation ID of said drive request matches said reservation ID of said disk drive.

15. The storage control system of claim 13, wherein said reservation management application further includes:
a queuing module configured for queuing said drive request upon determining said reservation ID of said drive request does not match said reservation ID of said disk drive.

16. The storage control system of claim 15, wherein said reservation management application further includes:
a cancellation module configured for canceling the reservation and sending all queued drive requests to said disk drive upon receiving a reservation cancel request.

17. The storage control system of claim 15, wherein said reservation management application further includes:
a timer module configured for sending an all requests complete callback and starting a reservation timer upon determining said disk drive has no outstanding drive requests, said determining whether said disk drive has an outstanding drive request occurring upon one of said assigning a reservation ID to a successful reservation request or completion of an outstanding drive request on said disk drive.

18. The storage control system of claim 17, wherein said reservation management application further includes:
an alarm module configured for canceling the reservation, sending all queued drive requests to said disk drive, and sending a reservation timeout callback upon expiration of said reservation timer.

19. The storage control system of claim 13, wherein said reservation management application further includes:
a resolution module configured for returning a reservation conflict upon receiving a reservation request and determining there is a reservation on a disk drive.

20. A computer program product stored on a computer readable medium usable with a programmable computer, the computer program product having computer-readable code embodied therein, the computer-readable code comprising:
one or more instructions for monitoring a disk drive reservation status;
one or more instructions for assigning a reservation ID to a successful reservation request, said successful reservation request determined upon receiving a reservation request and determining there is no reservation on a disk drive; and
one or more instructions for determining whether a reservation ID of a drive request matches a reservation ID of a disk drive upon receiving said drive request and determining said disk drive has a reservation.
